(19) United States
(12) Patent Application Publication
(10) Pub. No.: US 2024/0365154 A1
(43) Pub. Date: Oct. 31, 2024

(54) METHOD FOR TRANSMITTING INFORMATION, TERMINAL DEVICE, AND CHIP

(71) Applicant: GUANGDONG OPPO MOBILE TELECOMMUNICATIONS CORP., LTD., Dongguan (CN)

(72) Inventors: Yingpei HUANG, Dongguan (CN); Wenhong CHEN, Dongguan (CN); Zhihua SHI, Dongguan (CN); Yun FANG, Dongguan (CN); Zhe LIU, Dongguan (CN)

(21) Appl. No.: 18/768,397

(22) Filed: Jul. 10, 2024

Related U.S. Application Data
(63) Continuation of application No. PCT/CN2022/071887, filed on Jan. 13, 2022.

(51) Int. Cl. H04W 24/10

(52) U.S. Cl. CPC H04W 24/10

(57) ABSTRACT

Provided are a method for transmitting information and a terminal device. The method for transmitting information is applicable to a terminal device, and the method includes transmitting temporal correlation information to a network device. And the terminal device includes a processor and a memory configured to store at least one computer program, wherein the processor, when loading and running the at least one computer program stored in the memory, is caused to perform: transmitting temporal correlation information to a network device.

### CROSS-REFERENCE TO RELATED APPLICATION

This application is a continuation application of International Application No. PCT/CN2022/071887, filed on Jan. 13, 2022, the entire contents of which are incorporated herein by reference.

### TECHNICAL FIELD

The present disclosure relates to the field of mobile communications technologies, and in particular, relates to a method and apparatus for transmitting information, a terminal device, and a network device.

### BACKGROUND

In communication systems, accurate channel information is critical for the transmission of data. Therefore, it is essential to acquire accurate channel information.

### SUMMARY

Embodiments of the present disclosure provide a method and apparatus for transmitting information, a terminal device, and a network device.

Some embodiments of the present disclosure provide a method for transmitting information. The method is applicable to a terminal device and includes:

transmitting temporal correlation information and/or Doppler power spectrum information to a network device.

Some embodiments of the present disclosure provide a terminal device. The terminal device includes a processor and a memory configured to store at least one computer program. The processor, when loading and running the at least one computer program stored in the memory, is caused to perform the information transmission method as described above.

Some embodiments of the present disclosure provide a chip, the chip includes a processor. The processor, when loading and running at least one computer program stored in a memory, causes a device equipped with the chip to perform the information transmission method as described above.

Some embodiments of the present disclosure provide a non-transitory computer-readable storage medium, configured to store at least one computer program. The at least one computer program, when loaded and run by a computer, causes the computer to perform the information transmission method as described above.

### BRIEF DESCRIPTION OF DRAWINGS

The accompanying drawings illustrated herein are used to provide a further understanding of the present disclosure and form part of the present disclosure, and the exemplary embodiments of the present disclosure and the description thereof are used to explain the present disclosure and do not constitute any limitation to the present disclosure. In the accompanying drawings:

FIG. 1 is a schematic diagram of an application scenario according to some embodiments of the present disclosure;

FIG. 2 is a schematic flowchart of a method for transmitting information according to some embodiments of the present disclosure;

FIG. 3A is a schematic diagram of a distribution of a temporal correlation coefficient according to some embodiments of the present disclosure;

FIG. 3B is a schematic diagram of a distribution of a temporal correlation coefficient according to some embodiments of the present disclosure;

FIG. 4 is a schematic diagram of a distribution of a Doppler power spectrum according to some embodiments of the present disclosure;

FIG. 5 is a schematic flowchart of a method for transmitting information according to some embodiments of the present disclosure;

FIG. 6 is a schematic structural diagram of an apparatus for transmitting information according to some embodiments of the present disclosure;

FIG. 7 is a schematic structural diagram of an apparatus for transmitting information according to some embodiments of the present disclosure;

FIG. 8 is a schematic structural diagram of a communication device according to some embodiments of the present disclosure;

FIG. 9 is a schematic structural diagram of a chip according to some embodiments of the present disclosure; and

FIG. 10 is a schematic block diagram of a communication system according to some embodiments of the present disclosure.

### DETAILED DESCRIPTION

The technical solutions according to the embodiments of the present disclosure are described hereinafter in conjunction with the accompanying drawings in the embodiments of the present disclosure. The described embodiments are a part and not all of the embodiments of the present disclosure. Based on the embodiments in the disclosure, all other embodiments acquired by those skilled in the art without creative labor fall within the scope of protection of this disclosure.

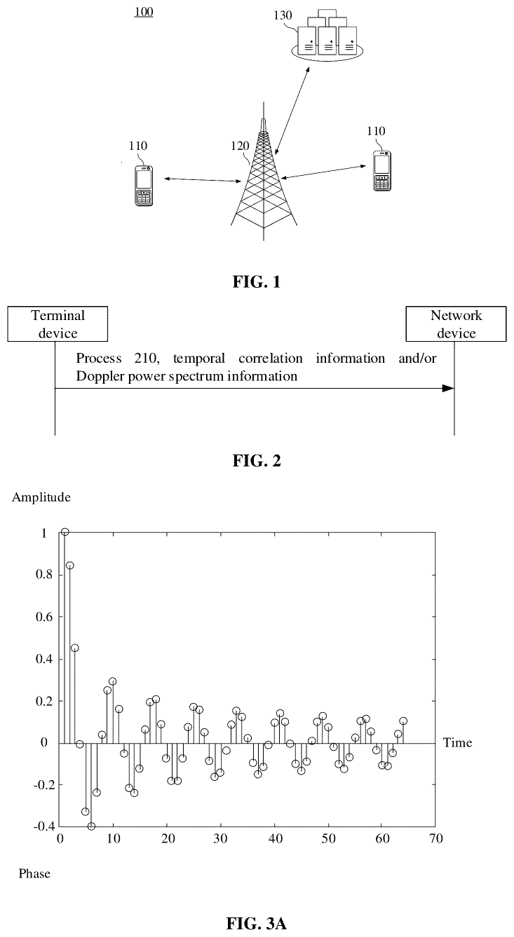

FIG. 1 is a schematic diagram of an application scenario according to some embodiments of the present disclosure.

As shown in FIG. 1, a communication system 100 includes a terminal device 110 and a network device 120. The network device 120 is communicated with the terminal device 110 over an air interface. Multi-service transmission is supported between the terminal device 110 and the network device 120.

It should be understood that the embodiments of the present disclosure give the description using the communication system 100 as an example, but the embodiments of the present disclosure are not limited thereto. That is, the technical solutions according to the embodiments of the present disclosure may be applicable to a variety of communication systems, such as a long-term evolution (LTE) system, an LTE time division duplex (TDD), a universal mobile telecommunication system (UMTS), an internet of things (IoT) system, a narrow band Internet of things (NB-IoT) system, an enhanced machine-type communications (cMTC) system, a 5G communication system (also known as New Radio (NR) communication system), or a future communication system.

In the communication system 100 shown in FIG. 1, the network device 120 is an access network device that communicates with the terminal device 110. The access network device provides communication coverage for a specific geographic area and is communicated with the terminal device 110 (e.g., a UE) within the coverage area.

The network device 120 is an evolutional node B (CNB or eNodeB) in the LTE system, a next-generation radio access network (NG RAN) device, a gNB in an NR system, or a radio controller in a cloud radio access network (CRAN); or the network device 120 is a relay station, an access point, an in-vehicle device, a wearable device, a hub, a switch, a bridge, a router, or a network device in a future evolutional public land mobile network (PLMN).

The terminal device 110 is any terminal device, which includes, but is not limited to, a terminal device that is wired or wirelessly connected to the network device 120 or to other terminal devices.

For example, the terminal device 110 refers to an access terminal, a user equipment (UE), a user unit, a user station, a mobile station, a remote station, a remote terminal, a mobile device, a user terminal, a terminal, a wireless communication device, a user agent, or a user device. The access terminal is a cellular phone, a cordless phone, a Session Initiation Protocol (SIP) phone, an IoT device, a satellite handheld terminal, a wireless local loop (WLL) station, a personal digital assistant (PDA), a handheld device with a wireless communication function, a computing device or other processing devices connected to a wireless modem, an in-vehicle device, a wearable device, a terminal device in a 5G network, or a terminal device in a future evolutionary network.

The terminal device 110 is used for device-to-device (D2D) communication.

The wireless communication system 100 also includes a core network device 130 that communicates with the network device 120. The core network device 130 is a 5G Core (5GC) device, such as an access and mobility management function (AMF), an authentication server function (AUSF), a user plane function (UPF), or a session management function (SMF). Optionally, the core network device 130 is also an evolved packet core (EPC) device of the LTE network, such as a session management function+Core Packet Gateway (SMF+PGW-C) device. It should be understood that SMF+PGW-C is capable of achieving the functions that SMF and PGW-C achieve at the same time. During network evolution, the above core network equipment is also called by other names, or new network entities are formed by dividing the functions of the core network, which are not limited herein.

The various functional units in the communication system 100 also communicate with each other by establishing a connection over a next-generation (NG) interface.

For example, the terminal device establishes an air interface connection with the access network device over an NR interface for transmitting user plane data and control plane signaling; the terminal device establishes a control-plane signaling connection with the AMF over an NG interface 1 (referred to as N1); the access network device, such as a next-generation wireless access base station (gNB), establishes a user-plane data connection with the UPF over an NG interface 3 (referred to as N3); the UPF establishes a control plane signaling connection with the SMF over an NG interface 4 (referred to as N4); the UPF interacts with the data network for the user plane data over an NG interface 6 (referred to as N6); the AMF establishes a control plane signaling connection with the SMF over an NG interface 11 (referred to as N11); and the SMF establishes a control plane signaling connection with the PCF over an NG interface 7 (referred to as N7).

FIG. 1 exemplarily illustrates a network device, a core network device, and two terminal devices. Optionally, the wireless communication system 100 includes a plurality of network devices, and the coverage area of each of the plurality of network devices includes other numbers of terminal devices, which is not limited herein.

It should be noted that FIG. 1 illustrates the system to which this disclosure applies by way of example only, but the methods shown in the embodiments of this disclosure may be applicable to other systems. In addition, the terms “system” and “network” are often used interchangeably herein. The term “and/or” in this document is merely a description of an association relationship of associated objects, indicating that three types of relationships may exist. For example, the phrase “A and/or B” means (A), (B), or (A and B). In addition, the symbol “/” generally denotes an “OR” relationship between contextual objects. It should also be understood that the term “indicate” mentioned in the embodiments of the present disclosure may be a direct indication, an indirect indication, or an indication of an associated relationship. For example, A indicating B may mean that A directly indicates B, such as B is accessed through A, or A indirectly indicates B, such as A indicates C, and B is accessed through C, or it may mean that there is an association between A and B. It should also be understood that the term “corresponding” mentioned in the embodiments of the present disclosure indicates a direct or indirect correspondence between the two, an association relationship between the two, or a relationship of instructing and being instructed, configuring and being configured, and the like. It should also be understood that the term “predefined” or “predefined rules” referred to in the embodiments of the present disclosure may be achieved by storing corresponding codes, forms, or other means that is defined to indicate relevant information in advance in a device (e.g., including a terminal device and a network device), and the specific ways of implementation are not limited herein. For example, the term “predefined” means “defined” in a protocol. It should also be understood that in the embodiments of the present disclosure, the “protocol” refers to a standard protocol in the field of communication, such as an LTE protocol, an NR protocol, and relevant protocols applied in future communication systems, which are not limited herein.

The design and performance for the algorithms, such as channel coding, channel estimation, channel equalization, signal processing, and the like, in the field of wireless communications are highly dependent on the characteristics of the channel. However, the channel is changing rapidly over time, with extreme randomness and complexity. Where the channel changes rapidly, the network equipment cannot estimate accurate channel information, which degrades the data transmission performance.

Based on this, some embodiments of the present disclosure provide a method for transmitting information. Specifically, a terminal device is capable of transmitting temporal correlation information and/or Doppler power spectrum information reflecting time-varying characteristics of a channel to a network device. In this way, the network device is capable of processing channel parameters reported by the terminal device based on the temporal correlation information and/or the Doppler power spectrum information, such that the channel parameters are better matched with the channel state, and more accurate channel parameters are acquired, thereby improving the throughput and system performance.

For case of understanding of the technical solutions according to the embodiments of the present disclosure, some specific embodiments are described in further detail hereinafter. The related art, as optional solutions, may be arbitrarily combined with the technical solutions according to the embodiments of the present disclosure, all of which fall within the scope of protection of the embodiments of the present disclosure. Embodiments of the present disclosure include at least some of the following.

FIG. 2 is a schematic flowchart of a method for transmitting information according to some embodiments of the present disclosure. As shown in FIG. 2, the method includes the following process.

In process 210, a terminal device transmits temporal correlation information and/or Doppler power spectrum information to a network device.

It should be understood that the temporal correlation information and/or the Doppler power spectrum information indicate the change of a channel within a period. The temporal correlation information indicates a correlation of channel information at different moments within a period, and the Doppler power spectrum information indicates a continuous spectrum by superimposing Doppler shifts of different waves and formed at Doppler frequency.

Optionally, the temporal correlation information and/or the Doppler power spectrum information are transmitted over dedicated signaling. In some embodiments, the temporal correlation information and/or the Doppler power spectrum information are carried in other control signaling to be reported to the network device. In addition, the temporal correlation information and/or the Doppler power spectrum information are also transmitted over a physical uplink shared channel (PUSCH). The embodiments of the present disclosure do not limit how the terminal device reports the above information.

Optionally, the temporal correlation information and/or the Doppler power spectrum information are configured by the network device to adjust channel parameters.

Optionally, the channel parameters include precoding matrix indicator (PMI), channel quality indication (CQI), and the like, which are not limited herein.

That is, upon receiving the temporal correlation information and/or the Doppler power spectrum information from the terminal device, the network device may adjust the channel parameters based on the temporal correlation information and/or the Doppler power spectrum information, such that the throughput and performance of the communication is improved by performing operations such as channel coding, channel estimation, channel equalization, or signal processing based on the adjusted channel parameters.

That is, the terminal device is capable of measuring the temporal correlation information and/or the Doppler power spectrum information and reporting the measured temporal correlation information and/or the measured Doppler power spectrum information to the network device. In this way, the network device is capable of processing the channel parameters reported by the terminal device using the temporal correlation information and/or the Doppler power spectrum information, such that the channel parameters are better matched with the channel state, thereby improving the throughput and performance of the communication.

The way in which the temporal correlation information is reported is described in further detail hereinafter.

Optionally, the temporal correlation information includes at least one temporal correlation coefficient.

A first temporal correlation coefficient of the at least one temporal correlation coefficient indicates a correlation between channel information corresponding to a first time unit and channel information corresponding to a second time unit. The first temporal correlation coefficient is any one of the at least one temporal correlation coefficient.

The first time unit is any time unit within a first length of time, the second time unit is a prescribed one of the time units within the first length of time, or, the second time unit is spaced apart from the first time unit by a predetermined length of time.

It should be noted that different temporal correlation coefficients in the above at least one temporal correlation coefficient correspond to different first time units.

That is, one temporal correlation coefficient indicates a correlation between channel information corresponding to two different time units (which are the first time unit and the second time unit). The larger the value of the correlation coefficient, the higher the correlation between the channel information corresponding to the two time units (which is interpreted as fewer variations in the channel information); and the smaller the value of the correlation coefficient, the lower the correlation between the channel information corresponding to the two moments mentioned above (which is also interpreted as more variations in the channel information).

It should be noted that the channel information corresponding to each time unit is measured by the terminal device at a particular moment (which is also understood as a particular time point) in each time unit. Herein, the specific moment is any one of the moments in the time unit, such as a first moment, a last moment, or an intermediate moment of the time unit, which is not limited herein.

In some embodiments, the terminal device is capable of measuring the channel information corresponding to a plurality of time units within the first length of time, and thus calculating a correlation between the channel information corresponding to each time unit and the channel information corresponding to another time unit (the second time unit), such that the at least one temporal correlation coefficient described above is acquired.

Optionally, the second time unit is a fixed time unit within the first length of time, and it should be understood that the fixed time unit is any time unit within the first length of time. For example, the second time unit is a first time unit, a second time unit, or a last time unit within the first length of time, which is not limited herein.

It should be noted that the first time unit and the second time unit are the same or different. In a case where the first time unit and the second time unit are the same, the channel coefficient corresponding to that first time unit is 1. In this scenario, the terminal device does not report this channel coefficient.

Exemplarily, the terminal device is capable of measuring channel information of each time unit in a length N of time and determining a correlation between the channel information of each time unit and channel information of a first moment, such that N temporal correlation coefficients are acquired. A first temporal correlation coefficient of the N temporal correlation coefficients takes a value of 1. The terminal device reports a second to an N^{th} temporal correlation coefficient to the network device.

Optionally, the second time unit is spaced apart from each of the above-described time units by a predetermined length of time. For example, the second time unit is spaced apart from each of the above-described time units by M time units, wherein M is an integer greater than or equal to 1.

It should be noted that the time unit is one or more orthogonal frequency division multiplexing (OFDM) symbols, one or more time slots, or one or more milliseconds, which is not limited herein.

In some embodiments of the present disclosure, the terminal device is capable of determining the channel information corresponding to each of the above time units based on one or more reference signal resources configured by the network device, such that at least one temporal correlation coefficient is acquired. The reference signal is a channel state information reference signal (CSI-RS) or a tracking reference signal (TRS), which is not limited herein.

Optionally, the first length of time is configured by the network device, agreed upon in advance by the terminal device and the network device, or selected by the terminal device, which is not limited herein.

Optionally, the number of the at least one temporal correlation coefficient described above is less than or equal to the maximum number of temporal correlation coefficients to be reported.

Optionally, the maximum number of temporal correlation coefficients is configured by the network device, agreed upon in advance by the terminal device and the network device, or selected by the terminal device, which is not limited herein.

Optionally, each temporal correlation coefficient includes an amplitude coefficient and/or a phase coefficient.

It should be understood that the temporal correlation coefficient is a real number. In a case where the temporal correlation coefficient is a real number, only the amplitude coefficient is included in the temporal correlation coefficient. In some embodiments, the temporal correlation coefficient is a complex number. In a case where the temporal correlation coefficient is a complex number, the temporal correlation coefficient includes both the amplitude coefficient and a phase coefficient.

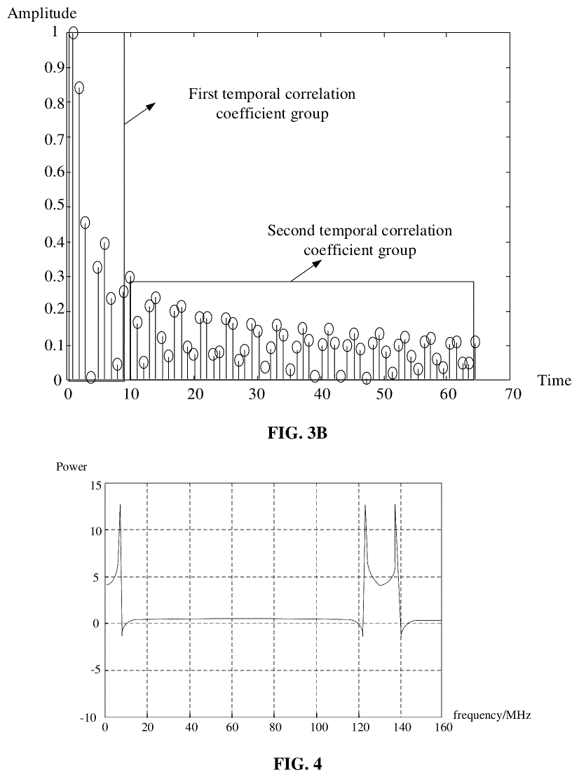

Exemplarily, a value of the at least one temporal correlation coefficient is represented in FIG. 3A. The horizontal axis is a time domain in units of time, and the vertical axes are an amplitude domain and a phase domain, respectively. Each line in FIG. 3A indicates a value of a correlation coefficient corresponding to a time unit. For example, a correlation coefficient corresponding to a time unit 10 has a value of 0.3 for an amplitude coefficient and a value of 0 for a phase coefficient.

Optionally, for reduction of the reporting overheads of the terminal device, the amplitude coefficient and/or the phase coefficient in the temporal correlation coefficient are quantization coefficients.

In some embodiments, the terminal device first calculates correlation parameters of two pieces of channel information and acquires amplitude values and/or phase values corresponding to the correlation parameters, respectively. Herein, the amplitude value and/or the phase value are floating-point type data, and the terminal device acquires a finally reported amplitude coefficient by quantifying the amplitude value and acquires a finally reported phase coefficient by quantifying the phase value, such that the reporting overheads are reduced.

In some embodiments, the terminal device acquires the above amplitude coefficient by performing a quantization process on the above amplitude value in a uniform quantization (e.g., linear quantization or logarithmic quantization) manner.

Optionally, the terminal device performs the quantization process on the amplitude value by linear quantization. Exemplarily, in a case where the amplitude domain takes values from 0 to 1, the amplitude domain is divided into serval amplitude intervals from 0 to 1. A length of each amplitude interval is 1/B, a value of B is 2\hat{ }k−1, and k is an integer greater than 1. Alternatively, the amplitude domain is divided into serval amplitude intervals from 1/C to 1, and a value of C is 2\hat{ }k. Here, each amplitude interval after the division corresponds to a quantization value, which is a minimum value of the amplitude in the interval or a maximum value of the amplitude in the interval, which is not limited herein. The terminal device determines in which interval the calculated amplitude value lies, and then the quantization value corresponding to that interval is determined as the final amplitude coefficient.

Optionally, the terminal device performs the quantization process on the amplitude value described above by logarithmic quantization, and adjacent quantization values are uniformly distributed over a logarithmic domain with a base of 2. Exemplarily, an amplitude interval between two adjacent quantization values is 1 dB, 1.5 dB, or 3 dB, which is not limited herein.

Optionally, the terminal device acquires the finally reported phase coefficient by using binary phase shift keying (BPSK), quadrature phase shift keying (QPSK), 8 phase shift keying phase shift keying (8PSK), or 16 phase shift keying phase shift keying (16PSK) to perform the quantization process on the above phase value, which is not limited herein.

In some embodiments, the amplitude coefficient is also determined based on a reference amplitude and a differential amplitude.

It should be understood that the differential amplitude is a result of performing the quantization process on the amplitude value. The reference amplitude is a fixed reference value, such as 2, 1, or 0.3, which is not limited herein.

Optionally, the amplitude coefficient is a product of each differential amplitude and the reference amplitude. In other words, the terminal device performs further processing on the above quantization result by the reference amplitude, such that the amplitude coefficient is closer to an actual measured correlation parameter, thereby improving the accuracy of the amplitude coefficient.

It should be noted that in a case where the terminal device determines the amplitude coefficient based on the reference amplitude and the differential amplitude, the terminal device also reports the reference amplitude to the network device.

In some embodiments, in a case where the number of at least one temporal correlation coefficient includes a plurality of temporal correlation coefficients, the plurality of temporal correlation coefficients are organized into a plurality of temporal correlation coefficient groups. Each temporal correlation coefficient group includes no or at least one temporal correlation coefficient.

It should be understood that the amplitude coefficient corresponding to the temporal correlation coefficient included in each group is determined by the reference amplitude and the quantization amplitude. The amplitude coefficients of the correlation coefficients in different temporal correlation coefficient groups are determined by different parameter amplitudes. That is, different groups of correlation coefficients correspond to different reference amplitudes.

Specifically, the terminal device first calculates an amplitude value of each temporal correlation parameter and acquires a plurality of differential amplitudes by performing a quantization process on the amplitude value of each temporal correlation parameter. Further, the terminal device groups the above plurality of differential amplitudes based on a grouping parameter and acquires the amplitude coefficient of the temporal correlation coefficient in each group by performing a process based on the reference amplitude corresponding to the group and the differential amplitude in the group, and then. The grouping parameter includes the number of groups and/or a start position and an end position for each group.

It should be noted that the above grouping parameter with respect to the temporal correlation coefficient group is configured by the network device or selected by the terminal device, which is not limited herein. Further, in a case where the grouping parameter is selected by the terminal device, the terminal device also reports the grouping parameter to the network device.

Exemplarily, with reference to FIG. 3B, the determined amplitude coefficients are organized into two groups: a first temporal correlation coefficient group and a second temporal correlation coefficient group. The first temporal correlation coefficient group has a reference amplitude of 1 and the second temporal correlation coefficient group has a reference amplitude of 0.3.

It should be further noted that the terminal device reports all of the temporal correlation coefficients included in each group (i.e., the temporal correlation coefficient group) to the network device, or the terminal device selectively reports the temporal correlation coefficients in each group. That is, in the temporal correlation information reported by the terminal device to the network device, each temporal correlation coefficient group includes no or at least one temporal correlation coefficient.

Optionally, the temporal correlation information indicates at least one temporal correlation coefficient by a first bitmap. That is, the terminal device reports the at least one temporal correlation coefficient to the network device by the first bitmap.

The way in which the Doppler power spectrum information is reported is described hereinafter in further detail.

Optionally, the Doppler power spectrum information includes at least one power spectrum coefficient and/or at least one discrete Fourier transformation (DFT) vector. The Doppler power spectrum information indicates Doppler power of each frequency component in a first frequency domain interval, and the Doppler power of each frequency component in the first frequency domain interval is determined based on the at least one power spectrum coefficient and/or the at least one DFT vector.

In some embodiments of the present disclosure, the terminal device is capable of calculating a Doppler power spectrum density based on a reference signal (e.g., CSI-RS/TRS) resource configured by the network device, and the Doppler power spectrum density is denoted by S. In this way, the terminal device is capable of decomposing the Doppler power spectrum density S as calculated and acquiring at least one power spectrum coefficient and/or at least one DFT vector. In this way, the terminal device is capable of reporting the at least one power spectrum coefficient and/or the at least one DFT vector and indicating the Doppler power by the at least one power spectrum coefficient and/or the reported at least one DFT vector as reported.

It should be understood that at least one power spectrum coefficient and at least one DFT vector have an association relationship in a case where both the at least one power spectrum coefficient and the at least one DFT vector are included in the Doppler power spectrum information as described above.

The association relationship is a one-to-one relationship, such as one power spectrum coefficient corresponding to one DFT vector, or the association relationship is also a many-to-one relationship, such as a plurality of power spectrum coefficients corresponding to one DFT vector or one DFT vector corresponding to a plurality of power spectrum coefficients, which is not limited herein.

Optionally, one Doppler coefficient corresponds to one DFT vector of a length K, wherein K is an integer greater than 1.

In some embodiments, the Doppler power spectrum density S is a result acquired by multiplying each power spectrum coefficient and the corresponding DFT vector and summing the results of the product of each power spectrum coefficient and the corresponding DFT vector.

Optionally, the length K of the DFT vector is the number of time units included in the second length of time T. The second length of time T is the duration for the terminal device to report the above Doppler power spectrum information.

The number K of time units included in the second length T of time (i.e., the length of the DFT vector) is 2^{x}, 3^{y}, 5^{z}, or a product of at least two parameters of 2^{x}, 3^{y}, and 5^{z}, wherein x, y, and z are non-negative integers.

It should be noted that the second length of time and/or the number of time units included in the second length of time are configured by the network device or agreed upon in advance by the network device and the terminal device, which is not limited herein.

Alternatively, the time unit (which is also referred to as a time granule) is one or more OFDM symbols, one or more slots, or one or more milliseconds, which is not limited herein. The time unit is also determined by the period of the reference signal configured by the network device. For example, the time unit is one or more reference signal periods, which is not limited herein.

Optionally, the DFT is acquired by frequency domain sampling, wherein a frequency sampling rate is 1/T, and T is a duration (i.e., the second length of time) for which the Doppler frequency information is reported by the terminal device. Herein, the frequency sampling rate is configured by the network device or agreed upon in advance by the network device and the terminal device, which is not limited herein.

It should be noted that the power of the Doppler power spectrum density tends to be near zero in some frequency domains, and thus the terminal is capable of transmitting only a power spectrum coefficient and/or a DFT vector corresponding to a non-zero frequency domain interval (i.e., the first frequency domain interval) to the reporting window. Exemplarily, with reference to the schematic diagram of the distribution of Doppler power spectrum density shown in FIG. 4, the Doppler power of the Doppler power spectrum density is non-zero between 120 MHz and 140 MHz in the frequency domain, and thus the first frequency domain interval is from 120 MHz to 140 MHZ.

Optionally, a band length and/or a frequency domain start position of the above first frequency domain interval are configured by the network device or predefined by the terminal device, which is not limited herein.

Optionally, the number of the above at least one power spectrum coefficient is less than or equal to the maximum number of power spectrum coefficients to be reported. The maximum number of power spectrum coefficients is configured by the network device, agreed upon in advance by the terminal device and the network device, or selected by the terminal device, which is not limited herein.

In some embodiments of the present disclosure, the Doppler power spectrum densities are usually symmetrically distributed in the frequency domain, and the terminal device is capable of reporting only some of the power spectrum coefficients. For example, the terminal device reports power spectrum coefficients corresponding to a first-half interval of the first frequency domain interval, i.e., the interval from 120 MHz to 130 MHZ.

That is, the terminal device reports only D/2 or (D+1)/2 coefficients, wherein D is the total number of power spectrum coefficients corresponding to the entire first frequency domain interval. In this way, the network device determines the D coefficients corresponding to the first frequency domain interval based on the D/2 coefficients. F_{d}=F_{D-1-d}. F_{d} represents a power spectrum coefficient, and d is an integer greater than 1 and less than D. in a case where F_{d} is complex, F_{D-1-d} is equal to a real part of F_{d} and opposite to an imaginary part of F_{d}.

Optionally, each power spectrum coefficient includes an amplitude coefficient and/or a phase coefficient. It should be understood that the power spectrum coefficient is a real number. In a case where the power spectrum coefficient is a real number, only the amplitude coefficient is included in the power spectrum coefficient. In some embodiments, the power spectrum coefficient is a complex number. In a case where the power spectrum coefficient is a complex number, the power spectrum coefficient includes both the amplitude coefficient and the phase coefficient.

Optionally, for reduction of the reporting overheads of the terminal device, the amplitude coefficient and/or the phase coefficient in the power spectrum coefficient is a quantization coefficient.

In some embodiments, the terminal device is capable of decomposing the Doppler power spectrum density and acquiring a plurality of power spectrum parameters, and thus the terminal device then acquires an amplitude value and/or a phase value corresponding to the power spectrum parameter. Herein, the amplitude value and/or phase value are floating-point data, and the terminal device is capable of acquiring a finally reported amplitude coefficient by performing a quantization process on the amplitude value, such that the reporting overheads are reduced.

In some embodiments, the terminal device is capable of acquiring the above amplitude coefficient by performing the quantization process on the above amplitude value in a uniform quantization (e.g., linear quantization or logarithmic quantization) manner.

It should be noted that the quantization process performed by the terminal device on the amplitude parameter and the phase parameter of the power spectrum parameter is in the same manner as the above embodiments, which is not repeated herein for brevity.

In some embodiments, the amplitude coefficient in the power spectrum coefficient is determined based on a reference amplitude and a differential amplitude.

Optionally, a plurality of power spectrum coefficients are provided. The plurality of power spectrum coefficients are organized into a plurality of power spectrum coefficient groups. Each of the plurality of power spectrum coefficient groups includes no or at least one power spectrum coefficient.

It should be understood that the differential amplitude is a result of quantizing the amplitude value. The reference amplitude is a fixed reference value, such as 1, 0.3, or the like, which is not limited herein.

Optionally, the amplitude coefficient is a product of each differential amplitude and the reference amplitude. In other words, the terminal device further processes the quantization result using the reference amplitude, such that the amplitude coefficient is closer to an actual measured correlation parameter, thereby improving the accuracy of the amplitude coefficient.

It should be noted that in a case where the terminal device determines the above amplitude coefficient based on the reference amplitude and the differential amplitude, the terminal device also reports the reference amplitude to the network device.

In some embodiments, in a case where the number of at least one power spectrum coefficient includes a plurality of power spectrum coefficients, the plurality of power spectrum coefficients are organized into a plurality of power spectrum coefficient groups. Each of the plurality of power spectrum coefficient groups includes no or at least one power spectrum coefficient.

It should be understood that each power spectrum coefficient group includes a power spectrum coefficient, and the amplitude coefficient corresponding to the power spectrum coefficient group is determined based on the reference amplitude and the quantization amplitude. Moreover, the amplitude coefficients of the power spectrum coefficients in different power spectrum coefficient groups are determined by different parameter amplitudes. That is, different groups of power spectrum coefficients correspond to different reference amplitudes.

Specifically, the terminal device first calculates an amplitude value of each power spectrum parameter and acquires differential amplitudes by performing a quantization process on the amplitude value of each power spectrum parameter. Further, the terminal device groups the acquired plurality of differential amplitudes based on a grouping parameter and amplitude coefficients of the power spectrum coefficient in each group by performing a process based on a reference amplitude corresponding to the group and the differential amplitude in the group. The grouping parameter includes the number of groups and/or a start position and an end position for each group.

It should be noted that the terminal device reports all of the power spectrum coefficients included in each group (i.e., the power spectrum coefficient group) to the network device, or the terminal device selectively reports the power spectrum coefficients in each group. That is, in the Doppler power spectrum information reported by the terminal device to the network device, no or at least one power spectrum coefficient is included in each of the plurality of power spectrum coefficient groups.

Optionally, the Doppler power spectrum information indicates at least one power spectrum coefficient and/or at least one DFT vector by a second bitmap. That is, the terminal device reports the at least one power spectrum coefficient and/or the at least one DFT vector to the network device by the second bitmap.

In some other embodiments of the present disclosure, referring to FIG. 5, the method for transmitting information according to some embodiments of the present disclosure further includes the following process.

In process 220, the terminal device transmits capability indication information to the network device, wherein the capability indication information indicates that the terminal device has a capability of determining the temporal correlation information and/or the Doppler power spectrum information.

It should be understood that the terminal device also reports the capability of the terminal device to be able to report the temporal correlation information and/or the Doppler power spectrum information to the network device, prior to reporting the temporal correlation information and/or the Doppler power spectrum information to the network device. In this way, the network device is capable of determining whether to instruct the terminal device to report the temporal correlation information and/or the Doppler power spectrum information based on the capability indication information.

Optionally, based on process 220, as shown in FIG. 5, the method for transmitting information further includes the following process.

In process 230, the terminal device receives first configuration information from the network device, wherein the first configuration information is defined to configure a reference signal resource, and the reference signal resource is configured to determine the temporal correlation information and/or the Doppler power spectrum information.

It should be understood that the network device configures the reference signal resource for the terminal device based on the capability indication information reported by the terminal device, such that the terminal device is capable of measuring and reporting the temporal correlation information and/or the Doppler power spectrum information based on the reference signal. In some embodiments of the present disclosure, the reference signal is a CSI-RS or a TRS, which is not limited herein.

It should be noted that the capability indication information is transmitted over dedicated signaling or is carried in other messages (e.g., RRC connection request messages), which is not limited herein. The first configuration information is transmitted by dedicated signaling or is carried in other messages (e.g., RRC reconfiguration messages), which is not limited herein.

Optionally, based on process 220 and/or process 230, as shown in FIG. 5, the method for transmitting information further includes the following process.

In process 240, the terminal device receives second configuration information from the network device, wherein the second configuration information is defined to configure at least one of the following:
a first length of time;
a second length of time;
a number of time units included in the first length of time;
a number of time units included in the second length of time;
a maximum number of at least one temporal correlation coefficient;
a maximum number of at least one power spectrum coefficient;
a length of the DFT vector; or
a band length and/or a frequency domain start position of the first frequency domain interval.

It should be understood that before the terminal device reports the temporal correlation information and/or the Doppler power spectrum information, the terminal device also receives a relevant configuration regarding the reporting from the network device, according to which the temporal correlation information and/or the Doppler power spectrum information is reported.

It should be noted that the second configuration information is transmitted over dedicated signaling or carried in other messages (e.g., RRC reconfiguration messages), which is not limited herein. The first configuration information and the second configuration information are transmitted over the same message or different messages, which is not limited herein.

Optionally, in some embodiments of the present disclosure, the terminal device transmits first data to the network device over a PUSCH. The first data includes the temporal correlation information and/or the Doppler power spectrum information.

In some embodiments, the first data includes only the temporal correlation information and/or the Doppler power spectrum information. In other embodiments, the first data includes other information in addition to the temporal correlation information and/or the Doppler power spectrum information, which is not limited herein.

Optionally, the first data also includes first indication information. The first indication information is configured to indicate the length of the temporal correlation information and/or a length of the Doppler power spectrum information.

It should be understood that the length of the first indication information is a fixed value, which means that the first indication information has a fixed bit width. It should be noted that the bit width of the first indication information is agreed upon in advance by the terminal device and the network device or is determined based on parameters specified in the protocol, which is not limited herein.

Optionally, in a case where both the temporal correlation information and the Doppler power spectrum information are included in the first data, the first indication information indicates the length of the temporal correlation information and the length of the Doppler power spectrum information; alternatively, the first indication information indicates a total length of the temporal correlation information and the Doppler power spectrum information, which is not limited herein.

It should be noted that the length of the temporal correlation information is the number of temporal correlation coefficients included in the temporal correlation information or the total number of bits occupied by the temporal correlation information, which is not limited herein. Accordingly, the length of the Doppler power spectrum information is the number of power spectrum coefficients and/or the number of DFT vectors included in the Doppler power spectrum information, or is the total number of bits occupied by the Doppler power spectrum information, which is not limited herein.

That is, the terminal device in the embodiments of the present disclosure is capable of indicating the length of the temporal correlation information and/or the length of the Doppler power spectrum information included in the first data by the first indication information, such that the network device is capable of correctly parsing the first data and acquiring the complete temporal correlation information and/or the complete Doppler power spectrum information.

Typically, there is a limit to the length of a data packet of a PUSCH in a communication system. Based on this, the first data in some embodiments of the present disclosure is transmitted over one or more packets.

Optionally, in a case where the first data needs to be transmitted over multiple packets, at least a portion of the temporal correlation coefficients is included in each data packet; and/or, at least a portion of the power spectrum coefficients and/or at least a portion of the DFT vectors are included in each data packet.

That is, in the case where the first data needs to be transmitted over multiple packets, the terminal device splits the plurality of temporal correlation coefficients included in the temporal correlation information into a plurality of portions, such that the plurality of temporal correlation coefficients are transmitted over different data packets. Accordingly, the terminal device splits the plurality of power spectrum coefficients included in the Doppler power spectrum information into a plurality of portions and/or splits the plurality of DFT vectors into a plurality of portions to facilitate the transmitting over different data packets.

In some embodiments of the present disclosure, different temporal correlation coefficients correspond to different priorities, and/or, different power spectrum coefficients correspond to different priorities, and/or different DFT vectors correspond to different priorities. The priority herein indicates a degree of influence on the channel information. The higher the priority, the higher the degree of influence on the channel information; and conversely, the lower the priority, the lower the degree of influence on the channel information.

Optionally, the temporal correlation coefficient indicates the correlation between the channel information corresponding to two time units, and the terminal device is capable of determining a priority of the temporal correlation coefficient based on the length of time of an interval between the two time units corresponding to the temporal correlation coefficient. The shorter the length of time of the interval, the higher the priority corresponding to the temporal correlation coefficient.

Exemplarily, a k^{th} temporal correlation coefficient in the temporal correlation information indicates a correlation between channel information corresponding to the k^{th} time unit and channel information corresponding to a first time unit in the first length of time. k is an integer greater than or equal to 1 or less than or equal to N, and N is the total number of temporal correlation coefficients. Based on this, a priority value of the k^{th} temporal correlation coefficient is k. It should be understood that the lower the priority value of the temporal correlation coefficient, the higher the priority of the characterized coefficient.

Accordingly, priorities corresponding to the power spectrum coefficient and/or the DFT vector are determined similarly to those of the temporal correlation coefficients, which are not repeated herein.

Optionally, the terminal device splits the first data into a plurality of data packets based on the priority corresponding to the temporal correlation coefficient, and/or the priority corresponding to the power spectrum coefficient, and/or the priority corresponding to the DFT vector.

In some embodiments of the present disclosure, to improve the data transmission efficiency of the first data, the terminal device defines transmit priorities for different data packets. The terminal device transmits the above plurality of data packets based on the transmit priorities of the data packets. That is, the terminal device transmits a data packet with a high priority first, and transmits a data packet with a low priority later.

Exemplarily, in some embodiments of the present disclosure, the terminal device splits the first data into a plurality of data packets having different transmit priorities. The plurality of data packets include a first data packet and a second data packet (the first data packet and the second data packet are any two different data packets among the plurality of data packets). A transmit priority of the first data packet is higher than a transmit priority of the second data packet.

Optionally, the terminal device organizes the first data into the plurality of data packets in at least one of the following ways:
priorities corresponding to temporal correlation coefficients in the first data packet are all greater than priorities corresponding to temporal correlation coefficients in the second data packet;
priorities corresponding to power spectrum coefficients in the first data packet are all greater than priorities corresponding to power spectrum coefficients in the second data packet; or
priorities corresponding to DFT vectors in the first data packet are all greater than priorities corresponding to DFT vectors in the second data packet.

That is, in the temporal correlation information, the temporal correlation coefficients with higher priorities are transmitted first, while the temporal correlation coefficients with lower priorities are transmitted later. Correspondingly, in the Doppler power spectrum information, the power spectrum coefficients and/or the DFT vectors with higher priorities are transmitted first, and the power spectrum coefficients and/or the DFT vectors with lower priorities are transmitted second.

Exemplarily, first n bits (corresponding to n temporal correlation coefficients with higher priorities) in the first bitmap are transmitted over packets with higher transmit priorities, and next N-n bits (corresponding to N-n temporal correlation coefficients with lower priorities) are transmitted over packets with lower transmit priorities.

Optionally, bit information of temporal correlation coefficient information for indicating a non-zero temporal correlation coefficient or a non-zero power spectrum coefficient is transmitted over a data packet with a higher transmit priority, such that the network device is ensured to quickly parse the first data.

It should be noted that the first indication information for indicating the length of the temporal correlation information and/or the length of the Doppler power spectrum information are transmitted over a data packet with the highest priority, such that the network device is ensured to accurately parse the data in the plurality of data packets.

The preferred embodiments of the present disclosure are described in detail above in conjunction with the accompanying drawings. However, the present disclosure is not limited to the specific details in the above embodiments, and a variety of simple variations of the technical solutions according to the present disclosure may be performed within the scope of the technical conception of the present disclosure, and all of these simple variations fall within the scope of protection of the present disclosure. For example, the various specific technical features described in the above-described specific embodiments may be combined in any suitable manner without contradiction, and to avoid unnecessary repetition, the present disclosure does not separately describe the various possible ways of combination. For example, different embodiments of the present disclosure may be combined in any way, and as long as they do not contradict the idea of the present disclosure, these embodiments should be regarded as the contents disclosed in the present disclosure. For example, on the premise of no conflict, the various embodiments and/or the technical features in the various embodiments described in the present disclosure may be arbitrarily combined with each other and the related art, and the technical solutions acquired after the combination shall also fall within the scope of protection of the present disclosure.

It should also be understood that in the various method embodiments of the present disclosure, the serial number of each of the above-described processes does not imply the order of execution, and the order for executing the processes shall be determined by its function and inherent logic without constituting any limitation to the process of implementation of the embodiments of the present disclosure. Furthermore, in the embodiments of the present disclosure, the terms “downlink,” “uplink,” and “sidelink” are used to indicate the transmission direction of a signal or data, wherein the term “downlink” indicates that the signal or data is transmitted in a first direction from the site to the user equipment of the district; the term “uplink” indicates that the signal or data is transmitted in a second direction from the user equipment of the district to the site; and the term “sidelink” indicates that the signal or data is transmitted in a third direction from the user equipment 1 to the user equipment 2. For example, the term “downlink signal” indicates that the transmission direction of the signal is the first direction. In addition, in the embodiments of the present disclosure, the term “and/or” is merely a description of an association relationship of the associated objects, indicating that three types of relationships may exist. Specifically, the phrase “A and/or B” means (A), (B), or (A and B). In addition, the symbol “/”, as used herein, generally indicates that the associated objects are in an “or” relationship.

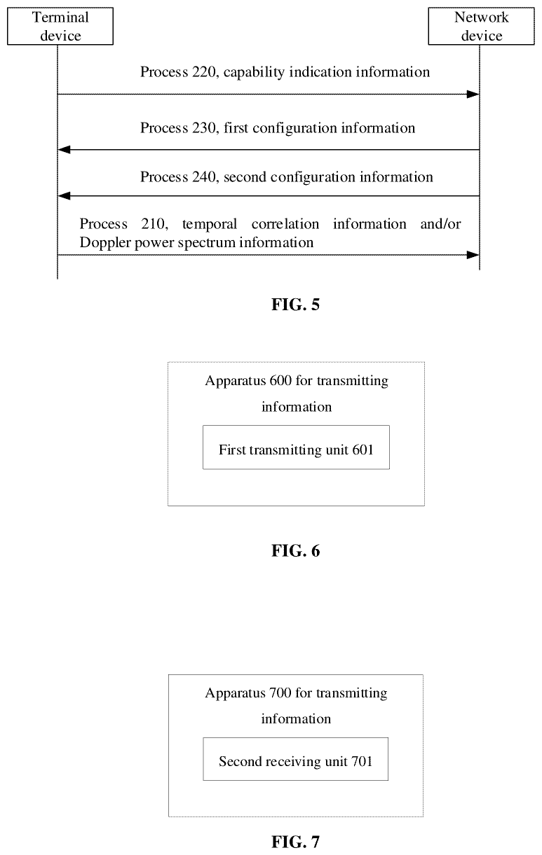

FIG. 6 is a schematic structural diagram I of an apparatus for transmitting information according to some embodiments of the present disclosure, which is applicable to a terminal device. As shown in FIG. 6, the apparatus 600 for transmitting information includes a first transmitting unit 601 configured to transmit temporal correlation information and/or Doppler power spectrum information to a network device.

Optionally, the temporal correlation information includes at least one temporal correlation coefficient.

Optionally, a first temporal correlation coefficient of the at least one temporal correlation coefficient indicates a correlation between channel information corresponding to a first time unit and channel information corresponding to a second time unit, and the first temporal correlation coefficient is any one of the at least one temporal correlation coefficient.

The first time unit is any time unit within a first length of time. The second time unit is a fixed time unit within the first length of time, or the second time unit is spaced apart from the first time unit by a predetermined length of time.

Optionally, each of the at least one temporal correlation coefficient includes an amplitude coefficient and/or a phase coefficient.

Optionally, the amplitude coefficient is determined based on a reference amplitude and a differential amplitude. The at least one temporal correlation coefficient includes a plurality of temporal correlation coefficients. The plurality of temporal correlation coefficients are organized into a plurality of temporal correlation coefficient groups. Each of the plurality of temporal correlation coefficient groups includes no or at least one temporal correlation coefficient.

Optionally, the at least one temporal correlation coefficient in the temporal correlation information is indicated by a first bitmap.

Optionally, the Doppler power spectrum information includes at least one power spectrum coefficient and/or at least one discrete Fourier transform DFT vector. The at least one power spectrum coefficient is associated with the at least one DFT vector.

Optionally, the Doppler power spectrum information indicates Doppler power of each frequency component in a first frequency domain interval, and the Doppler power of the each frequency component in the first frequency domain interval is determined based on the at least one power spectrum factor and/or the at least one DFT vector.

Optionally, a length of the DFT vector is the number of time units included in a second length of time, and the second length of time is a duration for reporting the Doppler power spectrum information.

Optionally, each of the at least one power spectrum coefficient includes an amplitude coefficient and/or a phase coefficient.

Optionally, the amplitude coefficient is determined based on a reference amplitude and a differential amplitude.

Optionally, the at least one power spectrum coefficient includes a plurality of power spectrum coefficients, a plurality of power spectrum coefficients are organized into a plurality of power spectrum coefficient groups. Each of the plurality of power spectrum coefficient groups includes no or at least one power spectrum coefficient.

Optionally, the at least one power spectrum coefficient and/or the at least one DFT vector included in the Doppler power spectrum information is indicated by a second bitmap.

Optionally, the first transmitting unit 601 is further configured to transmit capability indication information to the network device. The capability indication information indicates that the terminal device has a capability of determining the temporal correlation information and/or the Doppler power spectrum information.

Optionally, the apparatus 600 for transmitting information further includes a first receiving unit, configured to receive first configuration information from the network device. The first configuration information is defined to configure a reference signal resource. The reference signal resource is configured to determine the temporal correlation information and/or the Doppler power spectrum information.

Optionally, the first receiving unit is further configured to receive second configuration information from the network device. The second configuration information is defined to configure at least one of:
a first length of time;
a second length of time;
a number of time units in the first length of time;
a number of time units in the second length of time;
a maximum number of the at least one temporal correlation coefficient;
a maximum number of the at least one power spectrum coefficient;
a length of the DFT vector; or
a band length and/or a frequency domain start position of the first frequency domain interval.

Optionally, the temporal correlation information and/or the Doppler power spectrum information are transmitted over dedicated signaling.

Optionally, the first transmitting unit 601 is further configured to transmit first data to the network device over a PUSCH. The first data includes the temporal correlation information and/or the Doppler power spectrum information.

Optionally, the first data further includes first indication information. The first indication information indicates a length of the temporal correlation information and/or a length of the Doppler power spectrum information.

Optionally, the first data is transmitted over at least one data packet.

In a case where the at least one data packet includes a plurality of data packets, each of the plurality of data packets includes at least a portion of the at least one temporal correlation coefficient; and/or, each of the plurality of data packets includes at least a portion of the at least one power spectrum coefficient and/or at least a portion of the at least one DFT vectors.

Optionally, the at least one data packet includes the plurality of data packets, and different temporal correlation coefficients correspond to different priorities; and/or different power spectrum coefficients correspond to different priorities; and/or different DFT vectors correspond to different priorities; wherein
priorities corresponding to temporal correlation coefficients in a first data packet are all higher than priorities corresponding to temporal correlation coefficients in a second data packet;
priorities corresponding to power spectrum coefficients in a first data packet are all higher than priorities corresponding to power spectrum coefficients in a second data packet;
priorities corresponding to DFT vectors in a first data packet are all higher than priorities corresponding to DFT vectors in a second data packet; and
the first data packet and the second data packet are any two different data packets of the at least one data packet, and a transmit priority of the first data packet is higher than a transmit priority of the second data packet.

FIG. 7 is a schematic structural diagram II of an apparatus 700 for transmitting information according to some embodiments of the present disclosure, which is applicable to a network device. As shown in FIG. 7, the apparatus 700 for transmitting information includes a second receiving unit 701 configured to receive the temporal correlation information and/or the Doppler power spectrum information from the terminal device.

Optionally, the temporal correlation information includes at least one temporal correlation coefficient.

Optionally, the first temporal correlation coefficient of the at least one temporal correlation coefficient indicates a correlation between channel information corresponding to a first time unit and channel information corresponding to a second time unit, and the first temporal correlation coefficient is any one of the at least one temporal correlation coefficient.

The first time unit is any time unit within a first length of time. The second time unit is a fixed time unit within the first length of time, or the second time unit is spaced apart from the first time unit by a predetermined length of time.

Optionally, each of the at least one temporal correlation coefficient includes an amplitude coefficient and/or a phase coefficient.

Optionally, the amplitude coefficient is determined based on a reference amplitude and a differential amplitude. The at least one temporal correlation coefficient includes a plurality of temporal correlation coefficients. The plurality of temporal correlation coefficients are organized into a plurality of temporal correlation coefficient groups. Each of the plurality of temporal correlation coefficient groups includes no or at least one temporal correlation coefficient.

Optionally, the at least one temporal correlation coefficient in the temporal correlation information is indicated by a first bitmap.

Optionally, the Doppler power spectrum information includes at least one power spectrum coefficient and/or at least one discrete Fourier transform (DFT) vector. The at least one power spectrum coefficient is associated with the at least one DFT vector.

Optionally, the Doppler power spectrum information indicates Doppler power for each frequency component in a first frequency domain interval. The Doppler power for the each frequency component in the first frequency domain interval is determined based on the at least one power spectrum coefficient and/or the at least one DFT vector.

Optionally, a length of the DFT vector is the number of time units in a second length of time. The second length of time is a duration for reporting the Doppler power spectrum information.

Optionally, each of the at least one power spectrum coefficient includes an amplitude coefficient and/or a phase coefficient.

Optionally, the amplitude coefficient is determined based on a reference amplitude and a differential amplitude. The at least one power spectrum coefficient includes a plurality of the power spectrum coefficients. The plurality of power spectrum coefficients are organized into a plurality of power spectrum coefficient groups. Each of the plurality of power spectrum coefficient groups includes no or at least one power spectrum coefficient.

Optionally, the at least one power spectrum coefficient and/or the at least one DFT vector comprised in the Doppler power spectrum information is indicated by a second bitmap.

Optionally, the second receiving unit 701 is further configured to receive a capability indication information from the terminal device. The capability indication information indicates that the terminal device has a capability of determining the temporal correlation information and/or the Doppler power spectrum information.

Optionally, the apparatus 700 for transmitting information further includes a second transmitting unit configured to transmit first configuration information to the terminal device. The first configuration information is defined to configure a reference signal resource. The reference signal resource is configured to determine the temporal correlation information and/or the Doppler power spectrum information.

Optionally, the second transmitting unit is further configured to transmit second configuration information to the terminal device. The second configuration information is defined to configure at least one of:
a first length of time;
a second length of time;
a number of time units in the first length of time;
a number of time units in the second length of time;
a maximum number of at least one temporal correlation coefficient
a maximum number of at least one power spectrum coefficient;
a length of the DFT vector; or
a band length and/or a frequency domain start position of the first frequency domain interval.

Optionally, the temporal correlation information and/or the Doppler power spectrum information are transmitted over dedicated signaling.

Optionally, the second receiving unit 701 is configured to receive, over a PUSCH, first data from the terminal device. The first data includes the temporal correlation information and/or the Doppler power spectrum information.

Optionally, the first data further includes first indication information. The first indication information indicates a length of the temporal correlation information and/or a length of the Doppler power spectrum information.

Optionally, the first data is received by at least one data packet.

In a case where a plurality of data packets are provided, each of the plurality of data packets includes at least a portion of the at least one temporal correlation coefficient; and/or, each of the plurality of data packets includes at least a portion of the at least one power spectrum coefficient and/or at least a portion of the at least one DFT vectors.

Optionally, a plurality of data packets are provided and different temporal correlation coefficients correspond to different priorities, and/or different power spectrum coefficients correspond to different priorities, and/or different DFT vectors correspond to different priorities; wherein
priorities corresponding to temporal correlation coefficients in a first data packet are all higher than priorities corresponding to temporal correlation coefficients in a second data packet;
priorities corresponding to power spectrum coefficients in a first data packet are all higher than priorities corresponding to power spectrum coefficients in a second data packet;
priorities corresponding to DFT vectors in a first data packet are all higher than priorities corresponding to DFT vectors in a second data packet; and
the first data packet and the second data packet are any two different data packets of the at least one data packet, and a transmit priority of the first data packet is higher than a transmit priority of the second data packet.

It should be understood by those skilled in the art that the relevant description of the apparatus for transmitting information of the embodiments of the present disclosure may be understood with reference to the relevant description of the method for transmitting information of the embodiments of the present disclosure.

FIG. 8 is a schematic structural diagram of a communication device according to some embodiments of the present disclosure. The communication device is a terminal device or a network device. The communication device 800 shown in FIG. 8 includes a processor 810, and the processor 810, when loading and running at least one computer program from a memory, is caused to perform the methods according to the embodiments of the present disclosure.

Optionally, the communication device 800, as shown in FIG. 8, further includes a memory 820. The processor 810, when loading and running at least one computer program from the memory 820, is caused to perform the methods according to the embodiments of the present disclosure.

The memory 820 is a separate device from the processor 810 or is integrated into the processor 810.

Optionally, as shown in FIG. 8, the communication device 800 further includes a transceiver 830. The processor 810 controls the transceiver 830 to communicate with other devices, specifically, to transmit information or data to other devices or receive information or data from other devices.

The transceiver 830 includes a transmitter and a receiver. The transceiver 830 further includes an antenna, and the number of antennas is one or more than onc.

Optionally, the communication device 800 is specifically implemented as the network device in the embodiments of the present disclosure, and the communication device 800 is capable of implementing the processes implemented by the network device in the various methods according to the embodiments of the present disclosure, which is not repeated herein for brevity.

Optionally, the communication device 800 is specifically a mobile terminal/terminal device in the embodiments of the present disclosure, and the communication device 800 is capable of implementing the processes implemented by the mobile terminal/terminal device in the methods according to the embodiments of the present disclosure, which is not repeated herein for brevity.

FIG. 9 is a schematic structural diagram of a chip according to some embodiments of the present disclosure. The chip 900 shown in FIG. 9 includes a processor 910. The processor 910, when loading and running at least one computer program from a memory, is caused to perform the method in the embodiments of the present disclosure.

Optionally, as shown in FIG. 9, the chip 900 further includes a memory 920. The processor 910, when loading and running at least one computer program from the memory 920, is caused to perform the methods in the embodiments of the present disclosure.

The memory 920 is a separate device from the processor 910 or integrated into the processor 910.

Optionally, the chip 900 also includes an input interface 930. The processor 910 controls the input interface 930 to communicate with other devices or chips, specifically, to acquire information or data from other devices or chips.

Optionally, the chip 900 further includes an output interface 940. The processor 910 controls the output interface 940 to communicate with the other device or chip, specifically, to output information or data to the other devices or chips.

Optionally, the chip is applicable to a network device in the embodiments of the present disclosure, and the chip is capable of implementing the processes implemented by the network device in the methods according to the embodiments of the present disclosure, which is not repeated herein for brevity.

Optionally, the chip is applicable to a mobile terminal/terminal device in the embodiments of the present disclosure, and the chip is capable of implementing the processes implemented by the mobile terminal/terminal device in the methods according to the embodiments of the present disclosure, which are not repeated herein for brevity.

It should be understood that the chip in the embodiments of the present disclosure is also referred to as a system-on-chip, a system chip, or a chip system.

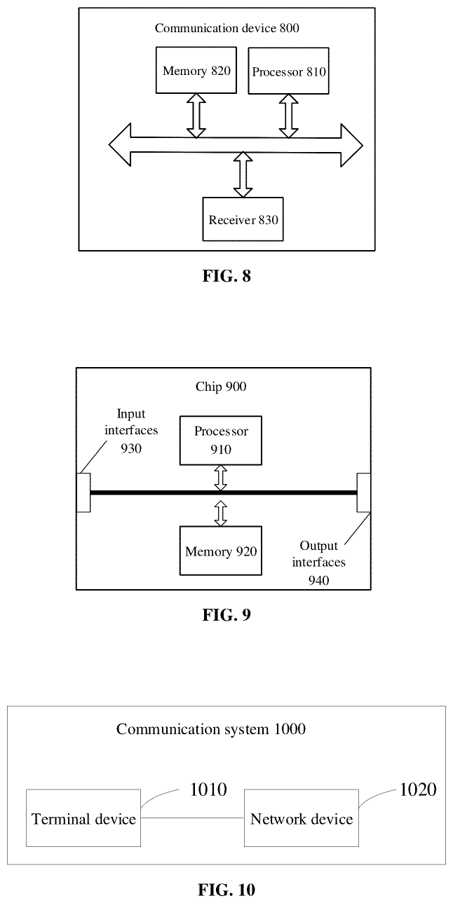

FIG. 10 is a schematic block diagram of a communication system 1000 according to some embodiments of the present disclosure. As shown in FIG. 10, the communication system 1000 includes a terminal device 1010 and a network device 1020.

The terminal device 1010 is configured to implement the functions implemented by the terminal device in the above-described method, and the network device 1020 is configured to implement the functions implemented by the network device in the above-described method, which are not repeated herein for brevity.

It should be understood that the processor according to some embodiments of the present disclosure is an integrated circuit chip with signal processing capabilities. In implementation, the processes of the method embodiments described above are accomplished by integrated logic circuits of hardware in the processor or instructions in the form of software. The above-described processor is a general processor, a digital signal processor (DSP), an application specific integrated circuit (ASIC), a Field programmable gate array (FPGA) or other programmable logic device, a discrete gate or transistor logic device, or a discrete hardware component, which may implement or perform various methods, processes, and logic block diagrams disclosed in the embodiments of the present disclosure. The general processor is a microprocessor or any conventional processor. The processes of the methods disclosed in conjunction with the embodiments of the present disclosure may be directly embodied as being performed by a hardware decoding processor or performed with a combination of hardware and software modules in the decoding processor. The software module may be stored in a random memory, a flash memory, a read-only memory, a programmable read-only memory or an electrically erasable programmable memory, a register, and other storage media well known in the art. The storage medium is included in a memory, and the processor reads the information in the memory to perform the processes of the method described above in conjunction with its hardware.

It will be appreciated that the memory in the embodiments of the present disclosure may be a transitory memory or a non-transitory memory or includes both the transitory memory and the non-transitory memory. The non-transitory memory is a read-only memory (ROM), a programmable read-only memory (PROM), an erasable programmable read-only memory (EPROM), an electrically erasable programmable read-only memory (EEPROM), or a flash memory. The transitory memory is a random access memory (RAM), which is used as an external cache. By way of illustration, but not limitation, many forms of RAM are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct Rambus RAM (DR RAM). It should be noted that the memories of the systems and methods described herein are intended to include, but are not limited to, these and any other suitable types of memory.

Some embodiments of the present disclosure further provide a computer-readable storage medium for storing at least one computer program.

Optionally, the computer-readable storage medium is applicable to a network device in the embodiments of the present disclosure, and the at least one computer program causes the computer to perform the processes implemented by the network device in the methods according to the embodiments of the present disclosure, which are not repeated herein for brevity.

Optionally, the computer-readable storage medium is applicable to a mobile terminal/terminal device in the embodiments of the present disclosure, and the at least one computer program causes the computer to perform the processes implemented by the mobile terminal/terminal device in the various methods according to the embodiments of the present disclosure, which are not repeated herein for brevity.

Some embodiments of the present disclosure further provide a computer program product including at least one computer program instruction therein.

Optionally, the computer program product is applicable to a network device in the embodiments of the present disclosure, and the at least one computer program instruction, when loaded and executed by a computer, causes the computer to perform the processes implemented by the network device in the methods according to the embodiments of the present disclosure, which are not repeated herein for brevity.

Optionally, the computer program product is applicable to a mobile terminal/terminal device in the embodiments of the present disclosure, and the at least one computer program instruction, when loaded and executed by a computer, causes the computer to perform the processes implemented by the mobile terminal/terminal device in the methods according to the embodiments of the present disclosure, which are not repeated herein for brevity.

Some embodiments of the present disclosure further provide at least one computer program.

Optionally, the at least one computer program is applicable to a network device in the embodiments of the present disclosure, and the at least one computer program, when loaded and run on a computer, causes the computer to perform the processes implemented by the network device in the methods according to the embodiments of the present disclosure, which are not repeated herein for brevity.

Optionally, the at least one computer program is applicable to the mobile terminal/terminal device in the embodiments of the present disclosure, and the at least one computer program, when loaded and run on a computer, causes the computer to perform the processes implemented by the mobile terminal/terminal device in the methods according to the embodiments of the present disclosure, which are not repeated herein for brevity.

It should be understood by those skilled in art that the units and algorithmic processes of the various examples described in the embodiments are capable of being implemented in electronic hardware, or a combination of computer software and electronic hardware. Whether these functions are performed in hardware or software depends on the particular application and design constraints of the technical solution. Those skilled in the art may use different methods to implement the described functions for each particular application, but such implementations should not be considered outside the scope of this application.

It should be clear to those skilled in the art that, for the convenience and brevity of description, the specific working processes of the above-described system, apparatus, and units may be referred to the processes in the foregoing embodiments of the methods, which are not repeated herein.

In the several embodiments according to the present disclosure, it should be understood that the system, apparatus, and method disclosed herein, may be implemented in other ways. For example, the above-described embodiments of the device are merely schematic. For example, the division of the units described above is merely a logical functional division. In practice, division of the units may be implemented in other ways, e.g., a plurality of units or components may be combined or may be integrated into another system, or some features may be ignored, or not implemented. As another point, the coupling or direct coupling or communication connection between each other shown or discussed may be an indirect coupling or communication connection through some interface, device, or unit, which may be electrical, mechanical, or otherwise.

The units illustrated as separated components may or may not be physically separated, and components shown as units may or may not be physical units, i.e., deployed in one place or distributed to a plurality of network units. Some or all of these units may be selected to implement the technical solutions according to the embodiments of the present disclosure according to actual needs.

Alternatively, the functional units in various embodiments of the present disclosure may be integrated into one processing unit, or each of the functional units may be physically present separately, or two or more units may be integrated into one unit.

The function may be stored in a computer-readable storage medium if it is implemented as a software functional unit and sold or used as a separate product. Based on this understanding, the essence of the technical solution of the present disclosure, the part that contributes to the related art, or the part of the technical solution may be embodied in the form of a software product. The software product is stored on a storage medium and includes instructions to cause a computer device (which may be a personal computer, a server, or a network device) to perform all or some of processes of the methods described in the embodiments of the present disclosure. The aforementioned storage medium includes a USB flash drive, a removable hard drive, a ROM, a RAM, a magnetic disc, a compact disc, a CD-ROM, or other media that stores program code.

Described above are merely exemplary embodiments of the present disclosure, but the scope of protection of the present disclosure is not limited thereto. Any modifications, substitutions, improvements, and the like made within the principles of the present disclosure shall be included in the protection scope of the present disclosure. Therefore, the scope of protection of this disclosure is defined by the claims.

1. A method for transmitting information, applicable to a terminal device, the method comprising:
transmitting temporal correlation information to a network device.

2. The method according to claim 1, wherein the temporal correlation information comprises at least one temporal correlation coefficient.

3. The method according to claim 2, wherein a first temporal correlation coefficient of the at least one temporal correlation coefficient indicates a correlation between channel information corresponding to a first time unit and channel information corresponding to a second time unit; wherein
the first temporal correlation coefficient is any one of the at least one temporal correlation coefficient; and
the second time unit is spaced apart from the first time unit by a predetermined length of time.

4. The method according to claim 2, wherein each of the at least one temporal correlation coefficient comprises at least one of an amplitude coefficient or a phase coefficient.

5. The method according to claim 2, wherein the at least one temporal correlation coefficient in the temporal correlation information is indicated by a first bitmap.

6. The method according to claim 1, further comprising:
transmitting capability indication information to the network device; wherein the capability indication information indicates that the terminal device has a capability to determine the temporal correlation information.

7. The method according to claim 1, further comprising:
receiving first configuration information from the network device; wherein the first configuration information is defined to configure a reference signal resource, the reference signal resource being configured to determine the temporal correlation information.

8. The method according to claim 1, wherein the terminal device transmits first data to the network device over a physical uplink shared channel (PUSCH), the first data comprising the temporal correlation information.

9. A terminal device, comprising: a processor and a memory configured to store at least one computer program, wherein the processor, when loading and running the at least one computer program stored in the memory, is caused to perform:
transmitting temporal correlation information to a network device.

10. The terminal device according to claim 9, wherein the temporal correlation information comprises at least one temporal correlation coefficient.

11. The terminal device according to claim 10, wherein a first temporal correlation coefficient of the at least one temporal correlation coefficient indicates a correlation between channel information corresponding to a first time unit and channel information corresponding to a second time unit; wherein
the first temporal correlation coefficient is any one of the at least one temporal correlation coefficient; and
the second time unit is spaced apart from the first time unit by a predetermined length of time.

12. The terminal device according to claim 10, wherein each of the at least one temporal correlation coefficient comprises at least one of an amplitude coefficient or a phase coefficient.

13. The terminal device according to claim 10, wherein the at least one temporal correlation coefficient in the temporal correlation information is indicated by a first bitmap.

14. The terminal device according to claim 9, wherein the processor, when loading and running the at least one computer program stored in the memory, is caused to further perform:
transmitting capability indication information to the network device; wherein the capability indication information indicates that the terminal device has a capability to determine the temporal correlation information.

15. The terminal device according to claim 9, wherein the processor, when loading and running the at least one computer program stored in the memory, is caused to further perform:
receiving first configuration information from the network device; wherein the first configuration information is defined to configure a reference signal resource, the reference signal resource being configured to determine the temporal correlation information.

16. The terminal device according to claim 9, wherein the terminal device transmits first data to the network device over a physical uplink shared channel (PUSCH), the first data comprising the temporal correlation information.

17. A chip, comprising: a processor, wherein the processor, when loading and running at least one computer program stored in a memory, causes a device equipped with the chip to perform:
transmitting temporal correlation information to a network device.

18. The chip according to claim 17, wherein the temporal correlation information comprises at least one temporal correlation coefficient.

19. The chip according to claim 18, wherein a first temporal correlation coefficient of the at least one temporal correlation coefficient indicates a correlation between channel information corresponding to a first time unit and channel information corresponding to a second time unit; wherein
the first temporal correlation coefficient is any one of the at least one temporal correlation coefficient; and
the second time unit is spaced apart from the first time unit by a predetermined length of time.

20. A non-transitory computer-readable storage medium, configured to store at least one computer program, wherein the at least one computer program, when loaded and run by a computer, causes the computer to perform the method as defined in claim 1.
